(19) United States
(12) Patent Application Publication
(10) Pub. No.: US 2009/0078505 A1
(43) Pub. Date: Mar. 26, 2009

(54) Safety device

(75) Inventors: Scott C. Casebolt, St. Paul Park, MN (US); James H. Graef, The Woodlands, TX (US)

Correspondence Address: IPLM GROUP, P.A., POST OFFICE BOX 18455, MINNEAPOLIS, MN, 55418, US

(73) Assignee: D B Industries, Inc.

(21) Appl. No.: 11/858,334

(22) Filed: Sep. 20, 2007

(51) Int. Cl. A62B 35/00; G08B 21/02

(52) U.S. Cl. 182/231; 182/18; 254/266

(57) ABSTRACT

A safety device includes a locking mechanism connected to a first portion and a braking mechanism connected to a second portion. The locking mechanism includes at least one pawl and a biasing member urging the at least one pawl into an engaging position. The braking mechanism includes at least one tooth having an engaging surface, and the at least one pawl engages the engaging surface in the engaging position. The engaging position prevents rotation of the first portion in the first direction and allows rotation of the first portion in the second direction. A force of at least 250 pounds on the first portion allows the braking mechanism to rotate thereby allowing the first portion to rotate in the first direction. The braking mechanism is prevented from rotating when the force has been released from the first portion thereby preventing rotation of the first portion in the first direction.

### FIELD OF THE INVENTION

The present invention relates to a safety device limiting a load on a worker and providing indication that the worker may require assistance or rescue.

### BACKGROUND OF THE INVENTION

With regard to one possible application of the present invention, motorized tugger lines (winch lines on hoists commonly referred to as tuggers) are commonly used in the petroleum drilling industry to raise and/or lower equipment and/or workers up to and down from a derrick. A derrick is a framework over a drill hole (as of an oil well) for supporting boring tackle and/or for hoisting and lowering equipment and/or workers. Commonly, a worker will sit on a boatswains chair connected to the tugger line.

A risk of using motorized tugger lines is the possibility of workers getting caught on obstructions such as the oil derrick structure or other structures as the workers are being raised and/or lowered by the tugger lines. If a worker gets caught on an obstruction, the tugger continues to pull the tugger line thereby continuing to pull the worker, which could result in serious injury or death. “Man-rated” tuggers are available and typically include a clutch mechanism that limits the load of the tuggers to reduce the risk of injury to the workers. Once a predetermined load on the tugger line is reached, the “man-rated” tugger stops pulling the tugger line. However, even with “man-rated” tuggers having such a built-in safety precaution, the “man-rated” tuggers may actually provide a false sense of security and may still have risks of serious injury or death should workers get caught on obstructions. Typical “man-rated” tuggers lift from approximately 1,000 to 40,000 pounds, which is questionable for safety purposes.

Should a worker fall or get caught on an obstruction, the worker may be exposed to a load and may need assistance or to be rescued, especially if the worker has been injured. In some instances, it is critical to rescue a worker within a relatively short period of time. One example is to prevent the onset of orthostatic intolerance when unconscious and/or immobile workers are suspended in their harnesses unable to move their legs. Therefore, timely rescue may be critical.

The present invention addresses the problems associated with the prior art devices and provides for a safety device that limits the load on the worker and provides indication that the worker may require assistance or rescue.

### SUMMARY OF THE INVENTION

One aspect of the present invention provides a safety device including a housing, a cable, a drum, a locking mechanism, and a braking mechanism. The housing has a cavity. The cable has a first end, a second end, and an intermediate portion. The drum is rotatably mounted to the housing within the cavity. The first end of the cable is connected to the drum, the intermediate portion of the cable is wound about the drum, and the second end of the cable extends outward from the housing. The cable is paid out from the housing when the drum is rotated in a first direction and is retracted into the housing when the drum is rotated in a second direction. The locking mechanism and the braking mechanism interconnect the housing and the drum. The locking mechanism engages the braking mechanism when the drum is rotated in the first direction thereby preventing the cable from being paid out from the housing, wherein a predetermined force exerted upon the cable allows the braking mechanism to rotate thereby allowing the drum to rotate in the first direction and allowing the cable to be paid out from the housing.

Another aspect of the present invention provides a safety device including a locking mechanism connected to a first portion and a braking mechanism connected to a second portion. The locking mechanism includes at least one pawl and a biasing member, which urges the at least one pawl into an engaging position. The braking mechanism includes at least one tooth having an engaging surface, and the at least one pawl engages the engaging surface in the engaging position. The first portion is rotatable relative to the second portion in a first direction and a second direction, and the engaging position prevents rotation of the first portion in the first direction and allows rotation of the first portion in the second direction. A force of at least 250 pounds on the first portion allows the braking mechanism to rotate thereby allowing the first portion to rotate in the first direction. The braking mechanism is prevented from rotating when the force has been released from the first portion thereby preventing rotation of the first portion in the first direction.

Another aspect of the present invention provides a method for providing indication when a worker requires assistance. A safety device including a cable wound about a drum rotatably mounted within a housing is obtained. A braking mechanism prevents the drum from rotating in a first direction and paying out the cable. The housing is connected to an anchorage point, and the cable is connected to a safety equipment used by the worker. A force of at least 250 pounds is exerted on the cable, the force overcomes the braking mechanism thereby allowing the drum to rotate in the first direction and allowing the cable to be paid out from the housing. An indication is provided that the cable has been paid out from the housing.

### BRIEF DESCRIPTION OF THE DRAWINGS

FIG. 1 is an exploded perspective view of a safety device constructed according to the principles of the present invention;

FIG. 2 is an exploded perspective view of a housing portion of the safety device shown in FIG. 1;

FIG. 3 is a front view of a drum of the safety device shown in FIG. 1;

FIG. 4 is a cross sectional view of the drum taken along lines 4-4 in FIG. 3;

FIG. 5 is a front view of the drum shown in FIG. 3 with a cable routed therethrough;

FIG. 6 is a rear view of the drum shown in FIG. 3;

FIG. 7 is an exploded side view of the drum shown in FIG. 3 and a locking mechanism of the safety device shown in FIG. 1;

FIG. 8 is a front view of the safety device shown in FIG. 1;

FIG. 9 is a rear view of the safety device shown in FIG. 1;

FIG. 10 is a front view of the locking mechanism and the brake mechanism in an engaging position;

FIG. 11 is a front view of the locking mechanism and the brake mechanism in a disengaged position;

FIG. 12 shows the safety device shown in FIG. 1 interconnecting a safety harness donned by a worker and a winch hoist line;

FIG. 13 shows a cable of the safety device shown in FIG. 1 paid out from the housing;

FIG. 14 is an exploded perspective view of the safety device shown in FIGS. 1 and 2; and

FIG. 15 shows an alarm connected to the safety device shown in FIG. 1.

### DETAILED DESCRIPTION OF A PREFERRED EMBODIMENT

A safety device constructed according to the principles of the present invention is designated by the numeral 100 in the drawings.

The safety device 100 includes a housing 101 with a first portion 102 and a second portion 105 that form a cavity 108 therebetween. The first portion 102 includes an aperture 176 and the second portion 105 includes an aperture 177, which is in alignment with the aperture 176 and is preferably smaller in size than the aperture 176. The first and second portions 102 and 105 are preferably made of plastic. A first load strap 103, which is preferably a rectangular plate member made of metal, is connected to the first portion 102 and includes an aperture 178 in alignment with the aperture 176. A second load strap 106, which is preferably a rectangular plate member made of metal, is connected to the second portion 105 and includes an aperture 179 in alignment with the aperture 177. The first and second load straps 103 and 106 strengthen the housing 101.

Proximate the top of the housing 101, the first and second portions 102 and 105 form a connector cavity 110 configured and arranged to receive a connector 120. A portion 121 of the connector 120 extends outward from the top of the housing 101, and a carabiner or other suitable connecting device may be connected to the portion 121 to connect the safety device 100 to another device or structure. Proximate the bottom of the housing, a cable outlet 109 provides an exit for a cable 152. The second housing portion 105 includes a spring connector 111, which is a protrusion proximate the cable outlet 109 about which an end 170 of a motor spring 168 is positioned.

Within the cavity 108 between the portions 102 and 105 proximate the top of the housing 101 are spacers 112, which receive fasteners 117, to interconnect the portions 102 and 105. Proximate the bottom and sides of the housing 101 are couplers 113, which receive fasteners 117, to interconnect the portions 102 and 105. Proximate the middle of portions 102 and 105 are apertures 176 and 177, respectively, and a shaft 114 positioned proximate the middle of the portions 102 and 105 in alignment with the apertures 176 and 177, which receive fasteners 118 to interconnect the portions 102 and 105. A seal 172 seals housing 101 between the first and second portions 102 and 105 to prevent contaminants from getting into the cavity 108.

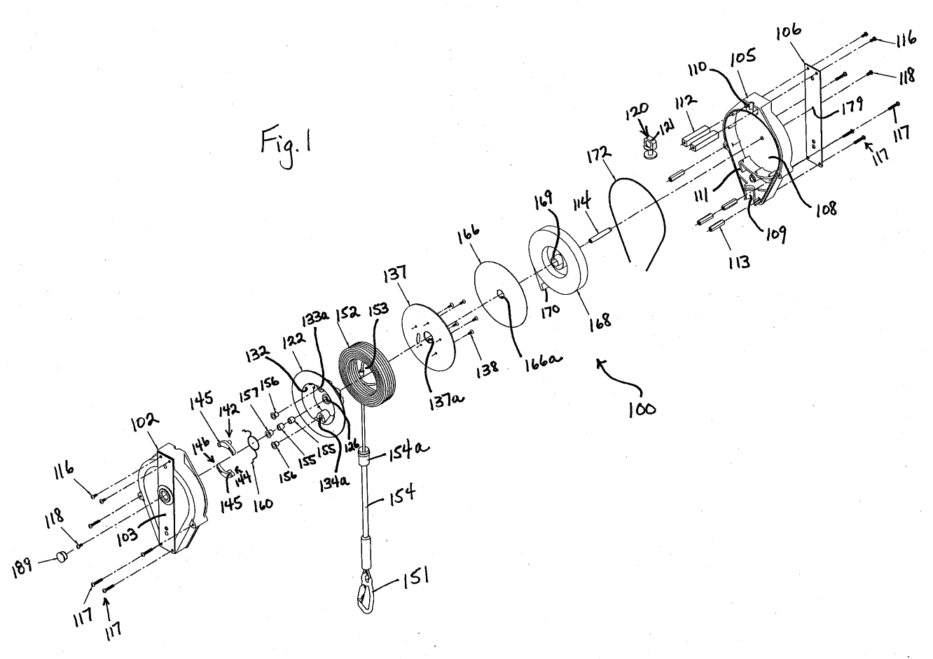

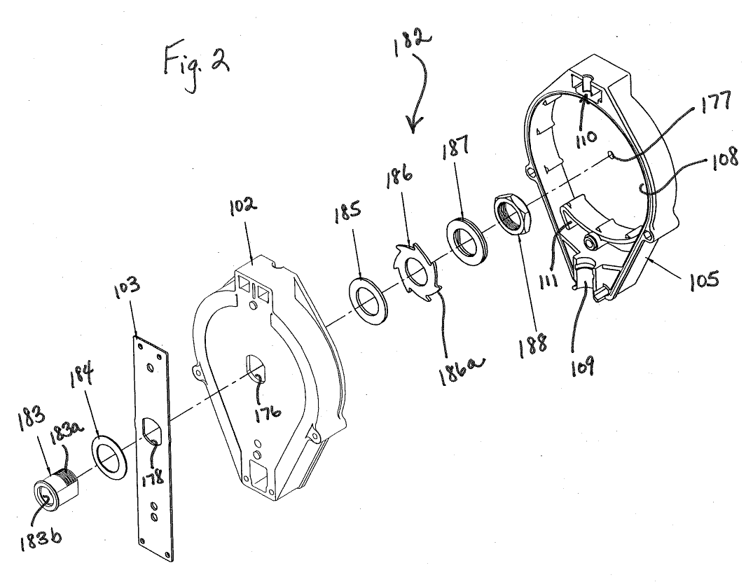

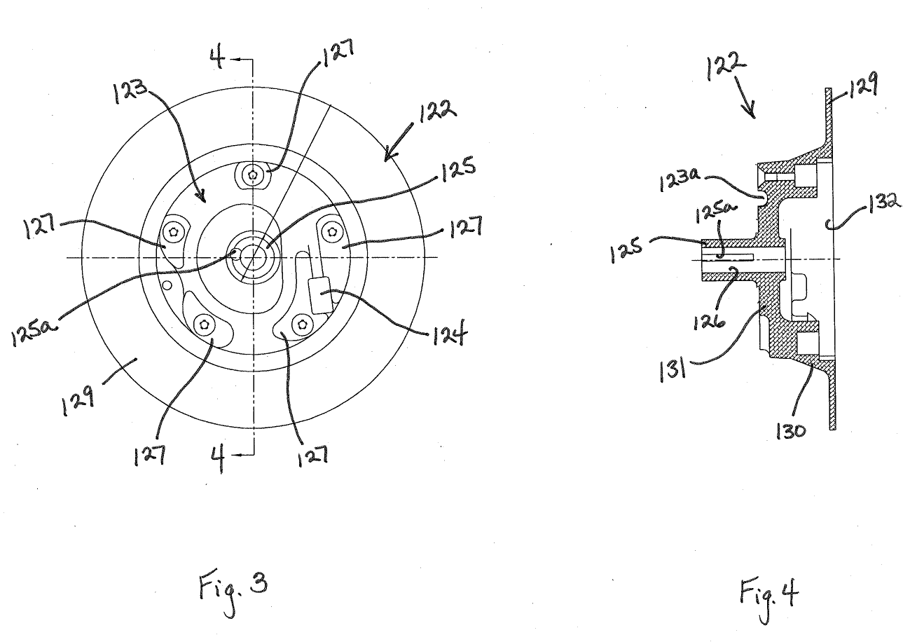

The first and second portions 102 and 105 house several other components of the safety device 100, and the cavity 108 is configured and arranged to contain the other components. The first portion 102 is shown assembled in FIG. 1 and is shown in an exploded perspective view in FIGS. 2 and 14. The first portion 102 includes the brake mechanism 182, which includes a ratchet cam 186. A brake hub 183 including a flanged portion extending outward from a cylindrical portion connects the ratchet cam 186 to the first portion 102. The cylindrical portion includes threading 183a proximate the end opposite the flanged portion, and a bore 183b extends longitudinally through the brake hub 183. The cylindrical portion of the brake hub 183 is inserted through an aperture in a spring disk 184, which is ring-like, and then is inserted through the aperture 178 in the first load strap 103 and the aperture 176 in the first portion 102. Also inserted onto the cylindrical portion of the brake hub 183 on the opposite side of the first portion 102 is a first friction disk 185, the ratchet cam 186, a second friction disk 187, and a lock nut 188. The lock nut 188 is threaded to mate with the threads 183a of the brake hub 183 to secure these components to the first portion 102. The ratchet cam 186 includes teeth 186a extending outward therefrom. Each tooth 186a includes a sliding surface 181a and an engaging surface 181b. The ratchet cam 186 is sandwiched between friction disks 185 and 187, which provide resistance so that the ratchet cam 186 preferably does not rotate about the brake hub 183 until a preset torque is reached. A cap 189 fits within the bore 183b proximate the flanged portion of the brake hub 183.

The other components that fit within the cavity 108 are shown in FIG. 1. A drum 122 includes a cylindrical portion 130 between and a flanged portion 129 extending outward therefrom and a plate portion 131 including an aperture 126. The flanged portion 129 is proximate the first portion 102 and includes an opening providing access to a cavity 132 within the cylindrical portion 130. The cylindrical portion 130 includes a first protrusion 133 with a bore 133a and a second protrusion 134 with a bore 134a extending inward into the cavity 132 from opposing sides of the cylindrical portion 130. The shaft 114 extends through the aperture 126. Bushings 157 and bearings 155 are installed within the aperture 126 to assist in allowing the drum 122 to rotate freely about the shaft 114.

A locking mechanism 141 includes pawls 142 connected to a spring 160, which fit within the cavity 132. Each pawl 142 includes a body portion 143, which is a crescent-shaped member, with a first end 144 and a second end 146. The first end 144 includes an aperture 145 and the second end 146 includes an engaging surface 147. Between the first and second ends 144 and 146, proximate the middle of the body portion 143, is a peg 148 extending laterally outward from the body 143. The peg 148 is configured and arranged to fit in the bores 133a and 134a. The peg 148 of one pawl 142 is positioned within the bore 133a, and the peg 148 of the other pawl 142 is positioned within the bore 134a. Bushings 156 allow the pawls 142 to pivot more easily about the pegs 148 in the bores 133a and 134a.

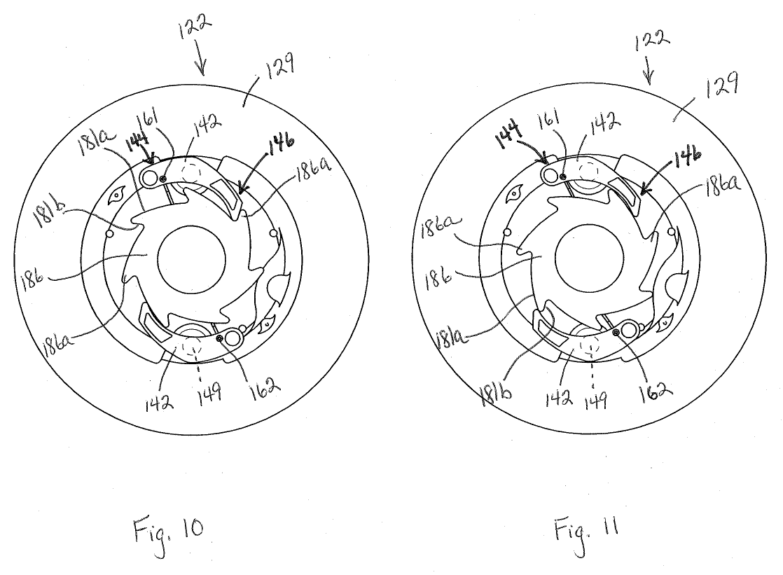

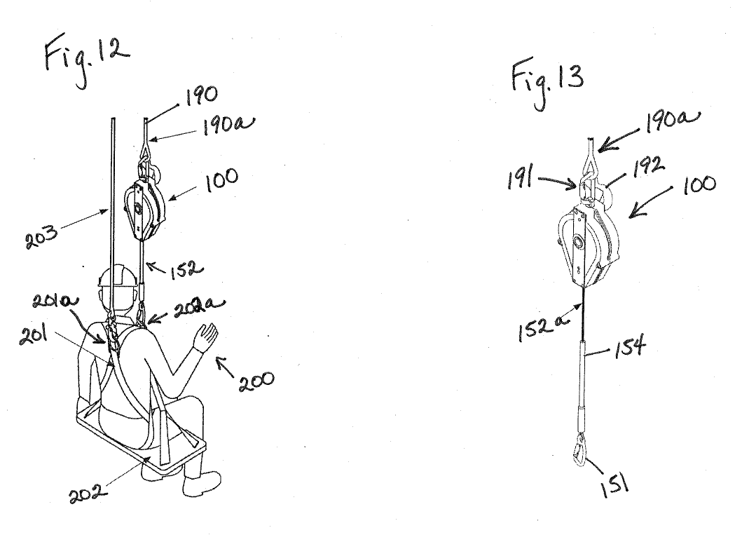

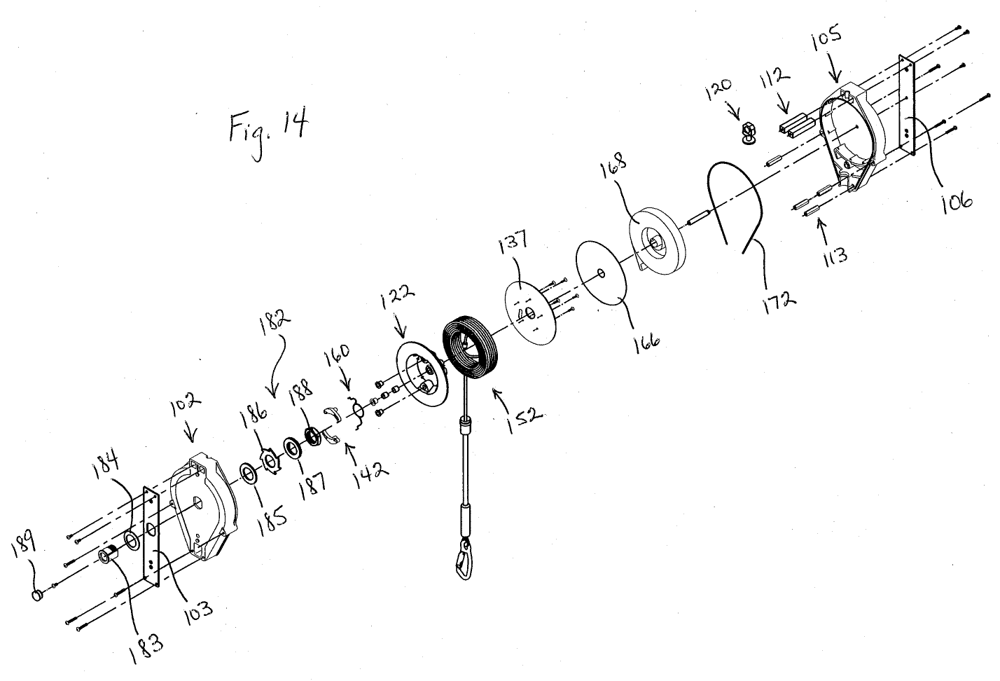

The spring 160 includes a first end 161 and a second end 162, which are configured and arranged to fit into the apertures 145 of the pawls 142 as shown in FIGS. 6 and 7. A ring-like intermediate portion 163 interconnects the first and second ends 161 and 162, which extend outward from opposing sides of the intermediate portion 163. The spring 160 biases the pawls 142 so that the first ends 144 of the pawls 142 are biased outward and the second ends 146 are biased inward relative to the intermediate portion 163. Thus, the pawls 142 are biased in an engaging position so that the engaging surfaces 147 are positioned to engage the engaging surfaces 181b of the teeth 186a of the ratchet cam 186, which extends into the cavity 132. Preferably at least one of the pawls 142 engages the engaging surface 181b of the teeth 186a of the ratchet ram 186 with its engaging surface 147, as shown in FIG. 10. When the drum 122 is rotated in a first direction, at least one of the pawls 142 engages the ratchet cam 186 and prevents the drum 122 from being further rotated. When the drum 122 is rotated in a second direction opposite the first direction, the pawls 142 pivot to slide over the sliding surfaces 181a, as shown in FIG. 11.

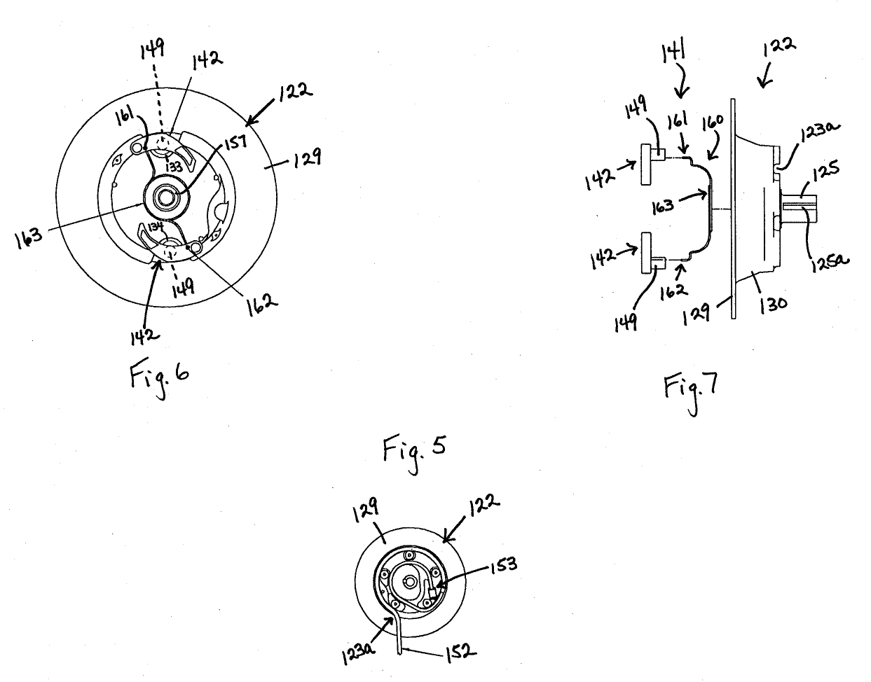

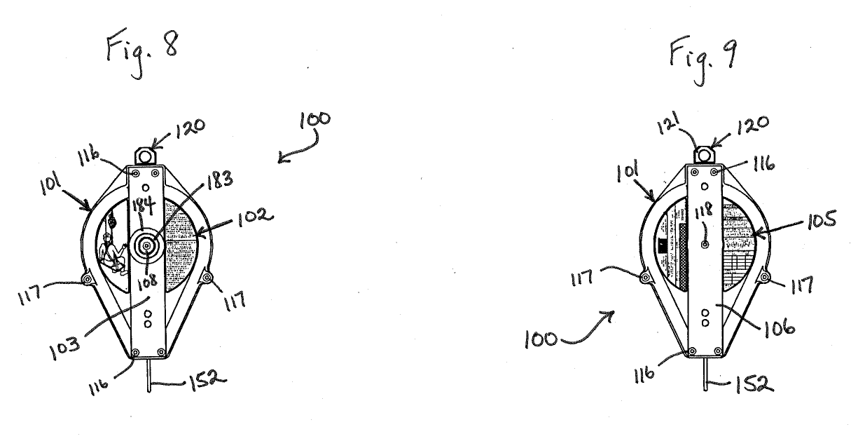

The plate portion 131 includes a cavity 123 formed in its side facing away from the flanged portion 129 and a shaft 125 extending outward proximate the middle of the plate portion 131. Within the cavity 123 are guides 127 connected to the plate portion 131 with fasteners, and the guides 127 form a pathway 123a through which an end of cable 152 is routed. A recess 124 secures the connecting end 153 of the cable 152 to the drum 122. As shown in FIG. 5, the cable 152 is routed through the pathway 123a and then exits the cavity 123 to be wound about the cylindrical portion 130 of the drum 122. The shaft 125 includes a slot 125a and a bore 126. The bore 126 extends longitudinally through the center of the shaft 125, and the slot 125a extends through an outer surface into the bore 126.

A drum plate 137 includes an aperture 137a, and the shaft 125 of the drum 122 is inserted through the aperture 137a. The drum plate 137 is connected to the plate portion 131 with fasteners 138 thus enclosing the end of the cable 152 within the cavity 123 and positioning an intermediate portion of the cable 152 between the flanged portion 129 and the drum plate 137. The shaft 125 extends outward from the drum plate 137. An isolation disk 166 including an aperture 166a provides a smooth surface against which a motor spring 168 is positioned. The shaft 125 is inserted through aperture 166a, and then a first end 169 of the motor spring 168 is inserted into slot 125a of the shaft 125. The intermediate portion of the motor spring 168 is wound about the shaft 125, and a second end 170 of the motor spring 168 engages the spring connector 111 of the second portion 105 of the housing 101. Thus, because the motor spring 168 wants to unwind, the motor spring 168 places a turning force on the drum 122 so that the cable 152 is urged to be wound about the drum 122.

The cable 152 preferably includes a colored portion 152a, which is preferably at least a portion of the intermediate portion of the cable 152. The colored portion 152 is preferably a bright color, such as yellow or orange, that is easily visually identified when that portion has been paid out from the housing 101. The cable 152 includes a stop 154, which prevents the end proximate the stop 154 from being retracted into the housing 101. A guide 154a fits in the cable outlet 109 and assists in reducing wear on the cable 152 as the cable 152 is paid out from and retracted into the housing 101. The end of the cable 152 includes a snap hook 151 for connecting the cable 152 to a worker or the worker's safety equipment.

The safety device 100 allows the use of non-man-rated winches for lifting workers or to reduce the loads to which workers could be exposed by man-rated winches when the workers are lifted by the winches. The safety device preferably lengthens by as much as thirty feet or more by allowing a cable, which is preferably yellow, orange, or some other bright color, to be pulled out of the safety device when subjected to a continuous load greater than the weight of the worker being lifted, preferably at least 250 pounds, and even more preferably at least 350 pounds. This limits the load applied to the workers who could have been caught up in the rig and giving the winch operator time to stop the winch. The force of the continuous load overcomes the resistance provided by the friction disks 185 and 187 thus allowing the ratchet cam 186 to rotate, which allows the drum 122 to rotate and pay out cable 152.

As shown in FIG. 12, safety device 100 could interconnect a boatswains chair 202 upon which a worker 200 sits and a winch hoist line 190 to convert a lifting winch into a “man-rated” winch or to supplement a “man-rated” winch by providing a clutching (slipping) action that activates if the worker 200 experiences excess loading, thus limiting the load on the worker 200 and providing indication that the worker 200 could need assistance or rescue thus reducing the likelihood of injury. A hook 151 connected to the end of the cable 152 is connected to a connector 202a of the boatswains chair 202, and a carabiner 191 interconnects the connector 120 of the safety device 100 and the end 190a of the winch hoist line 190. The hook 192 of the winch hoist line 190 is preferably not used if it is not auto-locking. The safety device 100 is preferably not a fall protection device, and it is recommended that a back-up fall protection device be used. The worker 200 should don a safety harness 201 including a dorsal D-ring 201a to which a fall protection device 203, such as a self-retracting lifeline or a vertical lifeline and a rope grab system, is connected. Alternatively, the safety device 100 could be connected to a front D-ring (not shown) of the safety harness 201.

Prior to raising the worker, the winch hoist line hook should be lowered to a safe access location. The worker should don her/his safety harness and connect the snap hook of the back-up fall protection device to the dorsal D-ring of the safety harness. The safety device is then connected to the winch hoist line. If the winch hoist line hook is not auto-locking, an auto-locking carabiner should be used to connect to the cable eye above the winch hoist line hook for added safety. The lower end of the safety device may then be connected to the worker's front D-ring or to the connector on the boatswains chair.

While being raised, if the worker gets caught on a structure, the safety device will begin to deploy to limit the load on the worker. When the drum 122 is rotated in a first direction, the pawls 142 biased in the engaging position (shown in FIG. 10) engage the teeth 186a of the ratchet cam 186 thus “locking” the locking mechanism 141 and providing resistance as the cable 152 is being paid out of the housing 101. This resistance assists in limiting the load on the worker. Preferably, a brightly colored cable will pay out and continue to deploy until the hoist line is stopped. The cable is paid out because the brake mechanism slips as the ratchet cam 186 rotates about the brake hub 183 when the preset torque is reached. Thus, to pay out the cable 152, the engaged ratchet cam 186 rotates about the brake hub 183 when a continuous load greater than the weight of the worker being lifted, preferably at least 250 pounds, and even more preferably at least 350 pounds, is placed on the cable 152. The cable 152 is paid out from the housing 101 and provides visual indication that the worker may require assistance or rescue. When the force is removed from the cable 152, the motor spring 168 causes the drum 122 to rotate and retract the cable 152 into the housing 101. The worker should always be in visual and/or audible communication with the winch operator so the suspended worker can order the winch operator to stop the winch before the safety device is fully deployed.

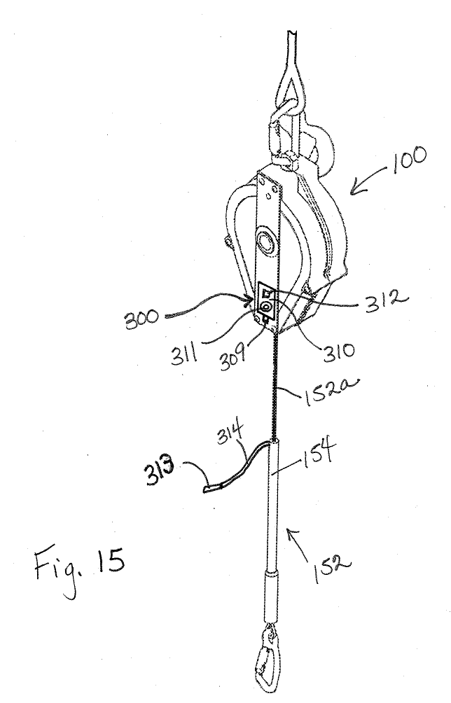

Optionally, the safety device 100 could also include an alarm 300, shown in FIG. 15. The alarm 300 preferably includes an alarm housing 310, which includes a speaker 311, connected to the housing 101 of the safety device 100. The housing 310 could also include an optional indicator light 312 on the front of the housing 310. The housing 310 may be integral with the speaker 311 and the indicator light 312. An activation pin 313 is releasably connected to a receptacle 309 of the housing 310, and a connecting member 314 interconnects the activation pin 313 and the stop 154 of the cable 152. When the cable 152 is paid out from the housing 101, the activation pin 313 is pulled out of the receptacle 309. When the activation pin 313 is disconnected from the housing 310, an alarm sounds through the speaker and the indicator light 112 illuminates to provide audio and visual indication that the activation pin 313 has been disconnected from the housing 310. The alarm could be battery operated or an air powered horn. Such alarm devices are well known in the art. An example of a suitable alarm device that may be used is disclosed in U.S. Pat. No. 5,903,219, which is incorporated by reference herein. Other types of alarms, such as but not limited to, audible alarms, visual alarms, and radio transmission alarms could also be used. For example, an electrical switch could be used and when the circuit is completed an alarm could be activated. Further, a signal could be transmitted from the safety device to a receiver with an alarm at another location to provide indication that the safety device has been deployed and the worker may need assistance or rescue. The alarms could be similarly connected to the safety device or connected by other means well known in the art.

After the winch is stopped, the winch hoist line and worker should be lowered to the ground so the safety device can be reset. To reset the safety device, the load is removed from the device and the cable is automatically retracted by the motor spring. When the drum 122 is rotated in a second direction opposite the first direction, the pawls 142 simply slide over the teeth 186a of the ratchet cam 186 (shown in FIG. 11) thus allowing the cable 152 to be retracted into the housing 101. The cable 152 is preferably automatically retracted into the housing by the motor spring 168. The safety device may be re-used. If the optional alarm 300 is used, the activation pin 313 may be inserted back into the receptacle 309 for re-use.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A safety device, comprising:
a housing having a cavity;
a cable having a first end, a second end, and an intermediate portion;
a drum rotatably mounted to the housing within the cavity, the first end of the cable being connected to the drum, the intermediate portion of the cable being wound about the drum, the second end of the cable extending outward from the housing, the cable being paid out from the housing when the drum is rotated in a first direction and being retracted into the housing when the drum is rotated in a second direction; and
a locking mechanism and a braking mechanism interconnecting the housing and the drum, the locking mechanism engaging the braking mechanism when the drum is rotated in the first direction thereby preventing the cable from being paid out from the housing, wherein a predetermined force exerted upon the cable allows the braking mechanism to rotate thereby allowing the drum to rotate in the first direction and allowing the cable to be paid out from the housing.

2. The safety device of claim 1, wherein the predetermined force is at least 250 pounds.

3. The safety device of claim 1, wherein the intermediate portion of the cable includes a colored portion providing visual indication when the colored portion has been paid out from the housing.

4. The safety device of claim 1, further comprising an alarm having a first portion and a second portion, the first portion being releasably connected to the second portion, the first portion being connected to the housing, the second portion being connected to the cable, wherein the first portion and the second portion are disconnected when the cable is paid out from the housing thereby providing indication that the cable has been paid out from the housing.

5. The safety device of claim 4, wherein the alarm is selected from the group consisting of an audible alarm, a visual alarm, and a radio transmission alarm.

6. The safety device of claim 1, wherein the locking mechanism includes at least one pawl and a spring biasing the pawl in an engaging position, the engaging position being when the locking mechanism engages the braking mechanism.

7. The safety device of claim 6, wherein the braking mechanism includes a ratchet cam with at least one tooth, the at least one pawl being configured and arranged to engage the tooth in the engaging position.

8. The safety device of claim 7, wherein the locking mechanism is connected to the drum and the braking mechanism is connected to the housing.

9. The safety device of claim 1, further comprising a spring interconnecting the housing and the drum, the spring urging the drum to rotate in a second direction.

10. A safety device, comprising:
a locking mechanism connected to a first portion, the locking mechanism including at least one pawl and a biasing member, the biasing member urging the at least one pawl into an engaging position;
a braking mechanism connected to a second portion, the braking mechanism including at least one tooth having an engaging surface, the at least one pawl engaging the engaging surface in the engaging position;
the first portion being rotatable relative to the second portion in a first direction and a second direction, the engaging position preventing rotation of the first portion in the first direction and allowing rotation of the first portion in the second direction; and
a force of at least 250 pounds on the first portion, the force allowing the braking mechanism to rotate thereby allowing the first portion to rotate in the first direction, the braking mechanism being prevented from rotating when the force has been released from the first portion thereby preventing rotation of the first portion in the first direction.

11. The safety device of claim 10, wherein the first portion is a drum and the second portion is a housing.

12. The safety device of claim 10, further comprising an alarm having a third portion and a fourth portion, the third portion being releasably connected to the fourth portion, the third portion being operatively connected to the first portion, the fourth portion being operatively connected to the second portion, wherein the third portion and the fourth portion are disconnected when the first portion is rotated in the first direction thereby providing indication selected from the group consisting of an audible alarm, a visual alarm, and a radio transmission alarm.

13. A method for providing indication when a worker requires assistance, comprising:
obtaining a safety device including a cable wound about a drum rotatably mounted within a housing, a braking mechanism preventing the drum from rotating in a first direction and paying out the cable;
connecting the housing to an anchorage point;
connecting the cable to a safety equipment used by the worker;
exerting at least 250 pounds of force on the cable, the force overcoming the braking mechanism thereby allowing the drum to rotate in the first direction and allowing the cable to be paid out from the housing; and
providing indication that the cable has been paid out from the housing.

14. The method of claim 13, wherein the anchorage point is a winch hoist line.

15. The method of claim 13, wherein the safety equipment is selected from the group consisting of a safety harness and a boatswains chair.

16. The method of claim 13, wherein the indication is a colored portion of the cable.

17. The method of claim 13, wherein the indication is an alarm.
